(19) United States
(12) Patent Application Publication
(10) Pub. No.: US 2018/0317232 A1
(43) Pub. Date: Nov. 1, 2018

(54) METHOD AND/OR SYSTEM FOR REDUCING UPLINK CHANNEL INTERFERENCE

(71) Applicant: QUALCOMM Incorporated, San Diego, CA (US)

(72) Inventors: Akash Kumar, Hyderabad (IN); Amit Jain, San Diego, CA (US); Ankit Maheshwari, Hyderabad (IN)

(21) Appl. No.: 15/499,571

(22) Filed: Apr. 27, 2017

(51) Int. Cl. H04W 72/08; H04W 24/08; H04W 24/10; H04B 17/318; H04W 76/00

(52) U.S. Cl. CPC H04W 72/082; H04W 24/08; H04W 76/007; H04W 24/10; H04B 17/318; H04W 72/085

(57) ABSTRACT

Methods and systems are disclosed for triggering a handover event on a mobile device in response to determining that an uplink channel potentially interferes with the at least one radio frequency function. In a particular implementation, the handover event may be triggered affecting a reported observation of received power of one or more signals.

### BACKGROUND

### Field

Subject matter disclosed herein relates to estimation of a location of a mobile device.

### Information

The location of a mobile device, such as a cellular telephone, may be useful or essential to a number of applications including emergency calls, navigation, direction finding, asset tracking and Internet service. The location of a mobile device may be estimated based on information gathered from various systems. In a cellular network implemented according to 4G (also referred to as Fourth Generation) Long Term Evolution (LTE) radio access, for example, a base station may transmit a positioning reference signal (PRS). In particular implementations, a mobile device may transmit and receive messages on LTE links while performing other radio frequency receiving functions such as processing satellite positioning system (SPS) signals and processing received Bluetooth® communications.

### SUMMARY

Briefly, one particular implementation is directed to a method at a mobile device comprising: determining whether a first uplink communication channel potentially interferes with at least one radio frequency (RF) receiving function; and in response to determining that the first uplink channel potentially interferes with the at least one RF receiving function, triggering a transition to use of a second uplink communication or a change to channel parameters of the first uplink communication channel by affecting a reported observation indicative of a channel condition.

Another particular implementation is directed to a mobile device comprising: at least one receiver enabling at least one radio frequency (RF) receiving function; and one or more processors configured to: determine whether a first uplink communication channel potentially interferes with the at least one receiving radio frequency function; and in response to determining that the first uplink communication channel potentially interferes with the at least one RF receiving function, triggering a transition to use of a second uplink communication channel or a change to channel parameters of the first uplink communication channel by affecting a reported observation indicative of a channel condition.

Another particular implementation is directed to a storage medium comprising computer-readable instructions stored thereon that are executable by one or more processors of a mobile device to: determine whether a first uplink communication channel to a first cell potentially interferes with at least one radio frequency (RF) receiving function of the mobile device; and in response to a determination that the first uplink communication channel potentially interferes with the at least one RF receiving function, trigger a transition to use of a second uplink communication channel or a change to channel parameters of the first uplink communication channel by affecting a reported observation indicative of a channel condition.

Another particular implementation is directed to a mobile device comprising: means for determining whether a first uplink communication channel potentially interferes with at least one radio frequency (RF) receiving function; and means for triggering a transition to use of a second uplink communication channel or a change to channel parameters of the first uplink communication channel by affecting a reported observation of indicative of a channel condition in response to a determination that the uplink channel to the first cell potentially interferes with the at least one RF receiving function.

It should be understood that the aforementioned implementations are merely example implementations, and that claimed subject matter is not necessarily limited to any particular aspect of these example implementations.

### BRIEF DESCRIPTION OF THE FIGURES

Claimed subject matter is particularly pointed out and distinctly claimed in the concluding portion of the specification. However, both as to organization and/or method of operation, together with objects, features, and/or advantages thereof, it may best be understood by reference to the following detailed description if read with the accompanying drawings in which:

FIG. 1 is an example architecture for terrestrial positioning;

FIG. 2 is a diagram showing operating frequencies of a mobile device receiver according to an embodiment;

FIG. 3 is a schematic diagram of an architecture of an example wireless communication network for support positioning according to an embodiment;

FIG. 4 is a flow diagram of a process to trigger a handover event according to an embodiment;

FIG. 5 is a schematic block diagram of a mobile device, in accordance with an example implementation; and

FIG. 6 is a schematic diagram of an example computing system according to an alternative implementation.

Reference is made in the following detailed description to accompanying drawings, which form a part hereof, wherein like numerals may designate like parts throughout that are identical, similar and/or analogous. It will be appreciated that the figures have not necessarily been drawn to scale, such as for simplicity and/or clarity of illustration. For example, dimensions of some aspects may be exaggerated relative to others. Further, it is to be understood that other embodiments may be utilized. Furthermore, structural and/or other changes may be made without departing from claimed subject matter. References throughout this specification to “claimed subject matter” refer to subject matter intended to be covered by one or more claims, or any portion thereof, and are not necessarily intended to refer to a complete claim set, to a particular combination of claim sets (e.g., method claims, apparatus claims, etc.), or to a particular claim. It should also be noted that directions and/or references, for example, such as up, down, top, bottom, and so on, may be used to facilitate discussion of drawings and are not intended to restrict application of claimed subject matter. Therefore, the following detailed description is not to be taken to limit claimed subject matter and/or equivalents.

### DETAILED DESCRIPTION

References throughout this specification to one implementation, an implementation, one embodiment, an embodiment, and/or the like mean that a particular feature, structure, characteristic, and/or the like described in relation to a particular implementation and/or embodiment is included in at least one implementation and/or embodiment of claimed subject matter. Thus, appearances of such phrases, for example, in various places throughout this specification are not necessarily intended to refer to the same implementation and/or embodiment or to any one particular implementation and/or embodiment. Furthermore, it is to be understood that particular features, structures, characteristics, and/or the like described are capable of being combined in various ways in one or more implementations and/or embodiments and, therefore, are within intended claim scope. However, these and other issues have a potential to vary in a particular context of usage. In other words, throughout the disclosure, particular context of description and/or usage provides helpful guidance regarding reasonable inferences to be drawn; however, likewise, “in this context” in general without further qualification refers to the context of the present disclosure.

According to an embodiment, a carrier operator deploying a Long-term Evolution (LTE) network may be required by regulators to provide an E911 service capable of furnishing estimated locations of mobile devices to emergency responders. The estimated locations may be obtained, at least in part, from observations of signals transmitted by a global navigation satellite system (GNSS) or observations of a positioning reference signal (PRS). A mobile device typically obtains observations for use in estimating a location of the mobile device using one or more radio frequency (RF) functions (e.g., using an RF receiver). A mobile device may employ other RF functions such as, for example, a Bluetooth® receiver enabling a wireless earpiece, for example.

An LTE network may enable a mobile device to communicate on any one of several uplink communication channels to one or more base stations. Particular available uplink communication channels, however, may interfere with or jam one or more other RF functions such as, for example, RF functions to receive and process GNSS signals or Bluetooth® signals.

According to an embodiment, a mobile device may selectively determine whether a currently used uplink communication channel is likely to interfere with or jam other RF functions (e.g., GNSS or Bluetooth®) that rely on processing RF signals received in a frequency band close to or in the frequency band of the currently used uplink communication channel. If a currently used uplink communication channel to a primary cell is likely to interfere with or jam other RF functions, the mobile device may trigger a handover event to transition uplink communications to a different, non-interfering uplink channel to a secondary cell.

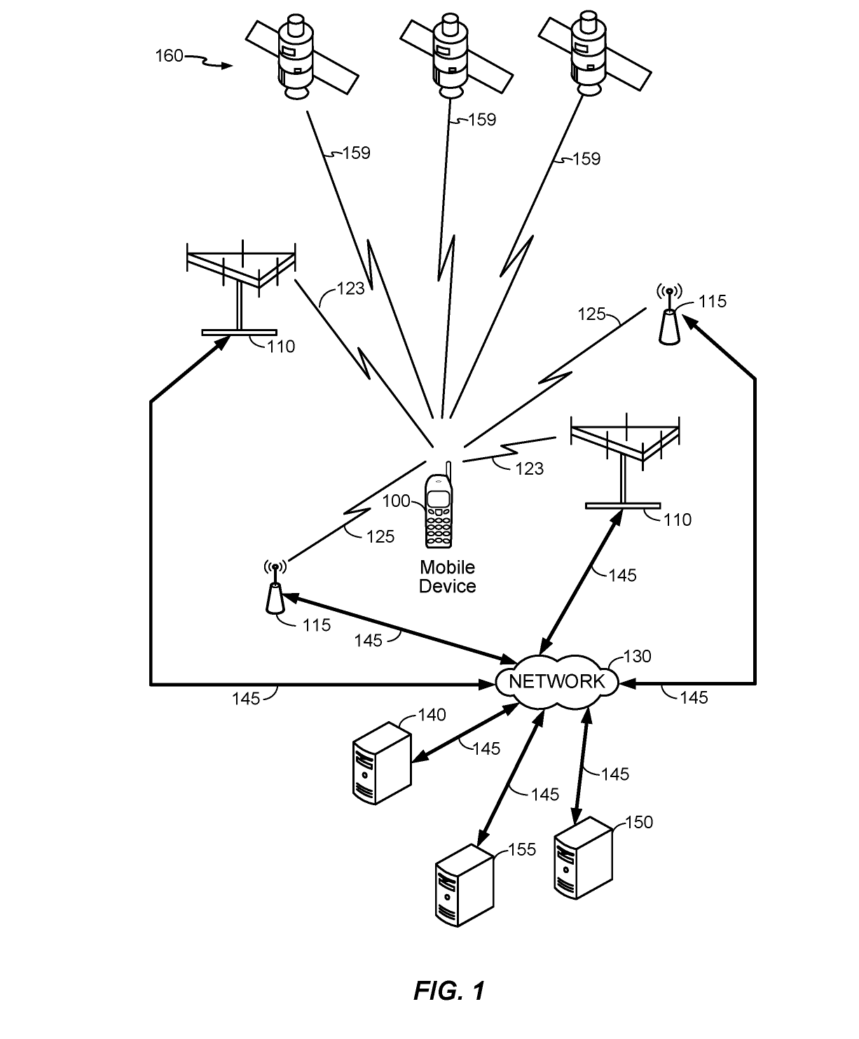

As shown in FIG. 1 in a particular implementation, mobile device 100, which may also be referred to as a UE (or user equipment), may transmit radio signals to, and receive radio signals from, a wireless communication network. In one example, mobile device 100 may communicate with a cellular communication network by transmitting wireless signals to, or receiving wireless signals from a cellular transceiver 110 which may comprise a wireless base transceiver subsystem (BTS), a Node B or an evolved NodeB (eNodeB) over wireless communication link 123. Similarly, mobile device 100 may transmit wireless signals to, or receive wireless signals from local transceiver 115 over wireless communication link 125. A local transceiver 115 may comprise an access point (AP), femtocell, Home Base Station, small cell base station, Home Node B (HNB) or Home eNodeB (HeNB) and may provide access to a wireless local area network (WLAN, e.g., IEEE 802.11 network), a wireless personal area network (WPAN, e.g., Bluetooth® network) or a cellular network (e.g. an LTE network or other wireless wide area network such as those discussed in the next paragraph). Of course it should be understood that these are merely examples of networks that may communicate with a mobile device over a wireless link, and claimed subject matter is not limited in this respect.

Mobile device 100 may receive or acquire satellite positioning system (SPS) signals 159 from SPS satellites 160. In some implementations, SPS satellites 160 comprising transmitters may be from one global navigation satellite system (GNSS), such as the GPS or Galileo satellite systems. In other implementations, the SPS Satellites may be from multiple GNSS such as, but not limited to, GPS, Galileo, Glonass, or Beidou (Compass) satellite systems. In other implementations, SPS satellites may be from any one several regional navigation satellite systems (RNSS′) such as, for example, WAAS, EGNOS, QZSS, just to name a few examples.

In particular implementations, and/or as discussed below, MD 100 may have circuitry and/or processing resources capable of computing a position fix or estimated location of MD 100. For example, MD 100 may compute a position fix based, at least in part, on pseudorange measurements to four or more SPS satellites 160. Here, MD 100 may compute such pseudorange measurements based, at least in part, on pseudonoise code phase detections in signals 159 acquired from four or more SPS satellites 160. In particular implementations, MD 100 may receive from server 140, 150 or 155 positioning assistance data to aid in the acquisition of signals 159 transmitted by SPS satellites 160 including, for example, almanac, ephemeris data, Doppler search windows, just to name a few examples.

Examples of network technologies that may support wireless communication link 123 are Global System for Mobile Communications (GSM), Code Division Multiple Access (CDMA), Wideband CDMA (WCDMA), Long Term Evolution LTE), High Rate Packet Data (HRPD). GSM, WCDMA and LTE are technologies defined by 3GPP. CDMA and HRPD are technologies defined by the 3rd Generation Partnership Project 2 (3GPP2). WCDMA is also part of the Universal Mobile Telecommunications System (UMTS) and may be supported by an HNB. Cellular transceivers 110 may comprise deployments of equipment providing subscriber access to a wireless telecommunication network for a service (e.g., under a service contract). Here, a cellular transceiver 110 may perform functions of a cellular base station in servicing subscriber devices within a cell determined based, at least in part, on a range at which the cellular transceiver 110 is capable of providing access service. Examples of radio technologies that may support wireless communication link 125 are IEEE 802.11, Bluetooth® (BT) and LTE.

In a particular implementation, cellular transceiver 110 and local transceiver 115 may communicate with servers 140, 150 and/or 155 over a network 130 through links 145. Here, network 130 may comprise any combination of wired or wireless links and may include cellular transceiver 110 and/or local transceiver 115 and/or servers 140, 150 and 155. In a particular implementation, network 130 may comprise Internet Protocol (IP) or other infrastructure capable of facilitating communication between mobile device 100 and servers 140, 150 or 155 through local transceiver 115 or cellular transceiver 110. In an embodiment, network 130 may also facilitate communication between mobile device 100, servers 140, 150 and/or 155. In another implementation, network 130 may comprise cellular communication network infrastructure such as, for example, a base station controller or packet based or circuit based switching center (not shown) to facilitate mobile cellular communication with mobile device 100. In a particular implementation, network 130 may comprise local area network (LAN) elements such as WiFi APs, routers and bridges and may in that case include or have links to gateway elements that provide access to wide area networks such as the Internet. In other implementations, network 130 may comprise a LAN and may or may not have access to a wide area network but may not provide any such access (if supported) to mobile device 100. In some implementations network 130 may comprise multiple networks (e.g., one or more wireless networks and/or the Internet). In one implementation, network 130 may include one or more serving gateways or Packet Data Network gateways. In addition, one or more of servers 140, 150 and 155 may be an E-SMLC, a Secure User Plane Location (SUPL) Location Platform (SLP), a SUPL Location Center (SLC), a SUPL Positioning Center (SPC), a Position Determining Entity (PDE) and/or a gateway mobile location center (GMLC), each of which may connect to one or more location retrieval functions (LRFs) and/or mobility management entities (MMEs) in network 130.

In particular implementations, and as discussed below, mobile device 100 may have circuitry and processing resources capable of obtaining location related measurements (e.g. for signals received from GPS or other Satellite Positioning System (SPS) satellites 160, cellular transceiver 110 or local transceiver 115 and possibly computing a position fix or estimated location of mobile device 100 based on these location related measurements. In some implementations, location related measurements obtained by mobile device 100 may be transferred to a location server such as an enhanced serving mobile location center (E-SMLC) or SUPL location platform (SLP) (e.g. which may be one of servers 140, 150 and 155) after which the location server may estimate or determine a location for mobile device 100 based on the measurements. In the presently illustrated example, location related measurements obtained by mobile device 100 may include measurements of signals 159 received from satellites 160 belonging to a Global Navigation Satellite System (GNSS) such as GPS, GLONASS, Galileo or Beidou and/or may include measurements of signals (such as 123 and/or 125) received from terrestrial transmitters fixed at known locations (e.g., such as cellular transceiver 110). Mobile device 100 or a separate location server may then obtain a location estimate for mobile device 100 based on these location related measurements using any one of several position methods such as, for example, GNSS, Assisted GNSS (A-GNSS), Advanced Forward Link Trilateration (AFLT), Observed Time Difference Of Arrival (OTDOA) or Enhanced Cell ID (E-CID) or combinations thereof. In some of these techniques (e.g. A-GNSS, AFLT and OTDOA), pseudoranges or timing differences may be measured at mobile device 100 relative to three or more terrestrial transmitters fixed at known locations or relative to four or more satellites with accurately known orbital data, or combinations thereof, based at least in part, on pilots, positioning reference signals (PRS) or other positioning related signals transmitted by the transmitters or satellites and received at mobile device 100. Here, servers 140, 150 or 155 may be capable of providing positioning assistance data to mobile device 100 including, for example, information regarding signals to be measured (e.g., signal timing), locations and identities of terrestrial transmitters and/or signal, timing and orbital information for GNSS satellites to facilitate positioning techniques such as A-GNSS, AFLT, OTDOA and E-CID. For example, servers 140, 150 or 155 may comprise an almanac which indicates locations and identities of cellular transceivers and/or local transceivers in a particular region or regions such as a particular venue, and may provide information descriptive of signals transmitted by a cellular base station or AP such as transmission power and signal timing. In the case of E-CID, a mobile device 100 may obtain measurements of signal strengths for signals received from cellular transceiver 110 and/or local transceiver 115 and/or may obtain a round trip signal propagation time (RTT) between mobile device 100 and a cellular transceiver 110 or local transceiver 115. A mobile device 100 may use these measurements together with assistance data (e.g. terrestrial almanac data or GNSS satellite data such as GNSS Almanac and/or GNSS Ephemeris information) received from a server 140, 150 or 155 to determine a location for mobile device 100 or may transfer the measurements to a server 140, 150 or 155 to perform the same determination. A call from mobile device 100 may be routed, based on the location of mobile device 100, and connected to a Public Safety Answering Point (PSAP) (not shown).

A mobile device (e.g. mobile device 100 in FIG. 1) may be referred to as a device, a wireless device, a mobile terminal, a terminal, a mobile station (MS), a user equipment (UE), a SUPL Enabled Terminal (SET) or by some other name and may correspond to a cellphone, smartphone, laptop, tablet, PDA, tracking device or some other portable or moveable device. Typically, though not necessarily, a mobile device may support wireless communication such as using GSM, WCDMA, LTE, CDMA, HRPD, WiFi, BT, WiMax, etc. A mobile device may also support wireless communication using a wireless LAN (WLAN), DSL or packet cable for example. A mobile device may comprise a single entity or may comprise multiple entities such as in a personal area network where a user may employ audio, video and/or data I/O devices and/or body sensors and a separate wireline or wireless modem. An estimate of a location of a mobile device (e.g., mobile device 100) may be referred to as a location, location estimate, location fix, fix, position, position estimate or position fix, and may be geographic, thus providing location coordinates for the mobile device (e.g., latitude and longitude) which may or may not include an altitude component (e.g., height above sea level, height above or depth below ground level, floor level or basement level). Alternatively, a location of a mobile device may be expressed as a civic location (e.g., as a postal address or the designation of some point or small area in a building such as a particular room or floor). A location of a mobile device may also be expressed as an area or volume (defined either geographically or in civic form) within which the mobile device is expected to be located with some probability or confidence level (e.g., 67% or 95%). A location of a mobile device may further be a relative location comprising, for example, a distance and direction or relative X, Y (and Z) coordinates defined relative to some origin at a known location which may be defined geographically or in civic terms or by reference to a point, area or volume indicated on a map, floor plan or building plan. In the description contained herein, the use of the term location may comprise any of these variants unless indicated otherwise.

The network architecture described previously in relation to FIG. 1 may be considered as a generic architecture that can fit a variety of outdoor and indoor location solutions including the standard SUPL user plane location solution defined by the Open Mobile Alliance (OMA) and standard control plane location solutions defined by 3GPP and 3GPP2. For example, server 140, 150 or 155 may function as (i) a SUPL SLP to support the SUPL location solution, (ii) an E-SMLC to support the 3GPP control plane location solution with LTE access on wireless communication link 123 or 125, or (iii) a Standalone Serving Mobile Location Center (SAS) to support the 3GPP Control Plane Location solution for UMTS.

As pointed out above, a mobile device (e.g., mobile device 100) may selectively determine whether a currently used uplink communication channel (e.g., on a wireless communication link 123) is likely to interfere with or jam other RF functions that rely on processing RF signals received in a frequency band close to or in the frequency band of the currently used uplink communication channel (e.g., SPS signals 159 received from space vehicles 160).

According to an embodiment, if a currently used uplink communication channel to a particular cell (e.g., a primary cell) is likely to interfere with or jam other RF functions, a mobile device may trigger a handover event to transition uplink communications to a different, non-interfering uplink channel to a different cell (e.g., secondary cell). Default behavior of a carrier network may comprise maintaining a particular optimal cell among multiple neighboring cells for a mobile device as a primary cell according to a ranking based on attributes. The carrier network may then request that the mobile device transmit measurement reports comprising observations of downlink signals (e.g., signal strength measurements) transmitted by multiple neighboring cells. According to an embodiment, a mobile device may trigger a handover event by increasing a reported measurement of received power of a downlink signal transmitted by the different cell. This may, for example, may affect a ranking of neighboring cells so as to rank the different cell above a current primary cell that is likely to interfere with or jam a receiving RF function. In an implementation, the particular cell may be operated by a first carrier operator and the different cell may be operated by a second carrier operator different from the first carrier operator.

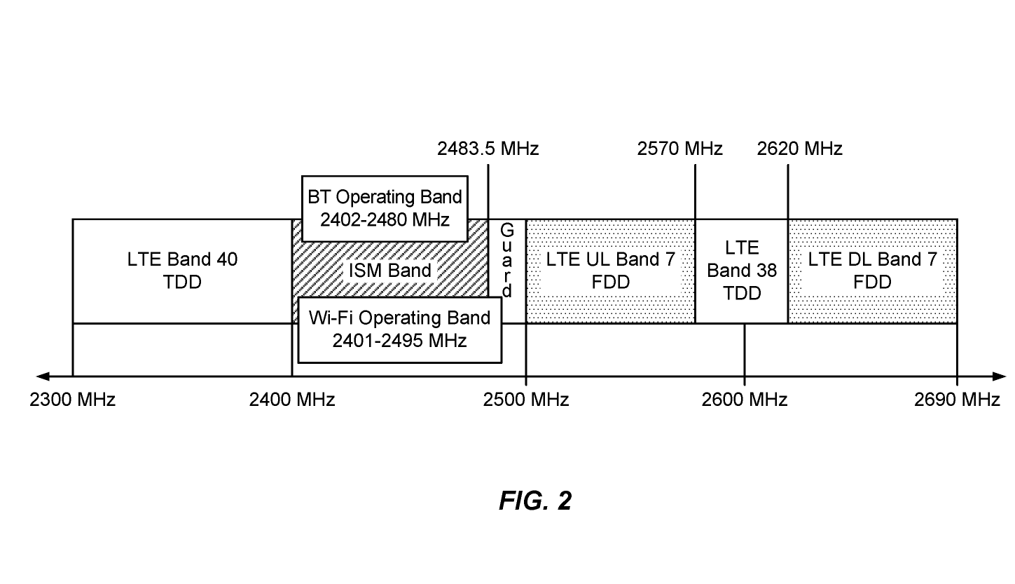

As illustrated in FIG. 2, for example, an operating band of transmitting and receiving devices of a mobile device may comprise a Bluetooth® operating band and a WiFi operating band overlapping an industrial, scientific and medical (ISM) band. Being adjacent to the Bluetooth® operating band, LTE TDD band B40 may interfere with or jam the Bluetooth® operating band. Similarly, an LTE FDD B7 band may interfere with a GNSS operating band or a Bluetooth® operating band. Additionally, uplink channel of LTE band 13 (777-787 MHz) and LTE band 14 (788-798 MHz) may interfere with a GNSS receiver processing SPS signals on an L1 frequency (1575.42 MHz). Here, it may be observed that the second harmonic of LTE band 13 (1554-1574 MHz) and the second harmonic of LTE band 14 (1576-1596 MHz) is close to a GNSS L1 frequency band (and may jam and/or interfere with a receiver attempting to acquiring a GNSS signal transmitted at the L1 frequency band). It should be understood, however that these are merely examples of uplink channel transmissions that may interfere with an RF receiving function, and claimed subject matter is not limited in this respect. Additional future uplink LTE bands, and related harmonics, may interfere or jam GNSS, Bluetooth® operating band, or operating bands of other receiver functions of a mobile device. In a particular implementation, a mobile device may determine whether a currently used uplink communication channel is likely to interfere with or jam other RF functions (e.g., GNSS or Bluetooth) using a look-up table stored in a memory. Such a look-up table may associate an RF function (e.g., RF receiving function) with uplink communication channels with a severity or likelihood of jamming to occur in connection with the RF function. Referring to the example above, such a look-up table may cross-reference an uplink of LTE band 13 or 14 as likely to interfere with a GNSS L1 band. In another embodiment, a mobile device communicating on a first uplink channel to a first cell may determine that a second uplink channel to a second cell does not interfere with an RF function in response to an E911 event based, at least in part, on a reported measurement of received power for the second cell.

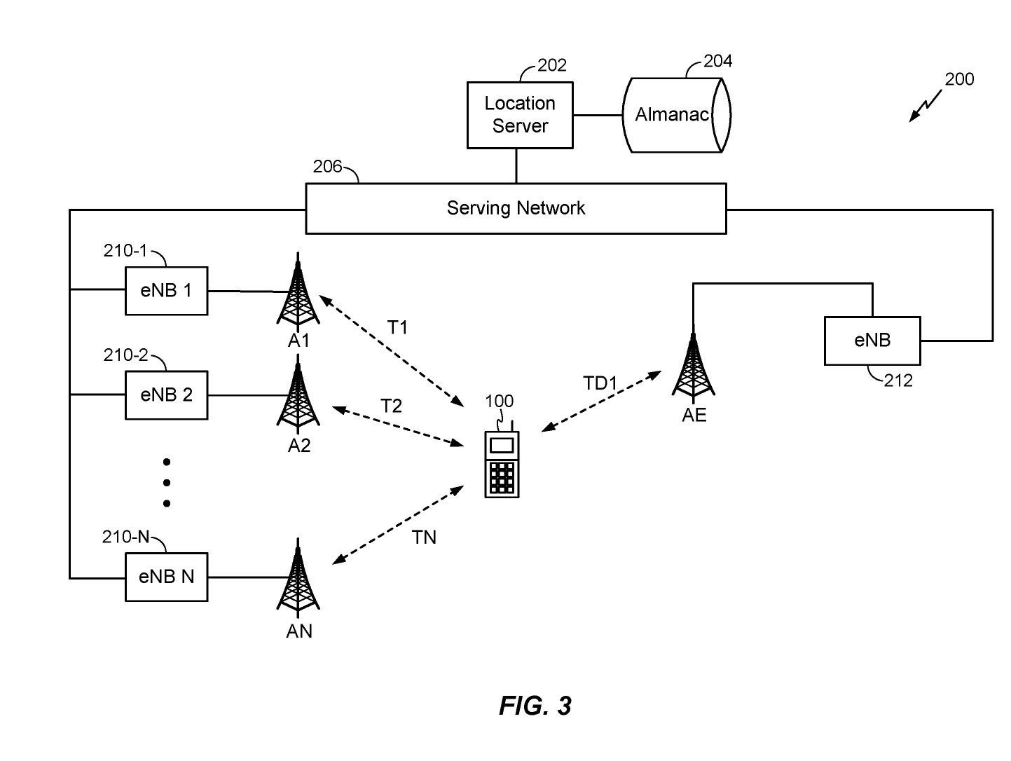

FIG. 3 shows an example implementation of the system shown in FIG. 1 including a wireless communication system 200 that may employ LTE access. Wireless communication system 200 includes a location server 202 and an almanac 204. Location server 202 and almanac 204 may be included as part of a serving network 206 or may be attached to or reachable from a serving network 206. Serving network 206 may include one or more access points such as eNB 1 210-1, eNB 2 210-2, eNB N, 210-N, and eNB 212. There may be other eNBs not explicitly shown in FIG. 2 such as eNBs n 210-n with n between 3 and N−1. Any one of the access points (e.g., eNB 212) may correspond to eNB 102 in FIG. 1. Each of the access points may be operably connected to one or more antennas. Antennas comprise A1, A2, . . . AN in the case of eNBs 210-1, 210-2 . . . 210-N, respectively, and AE in the case of eNB 212. An almanac 204 represents a database structure which may belong to serving network 206 and/or to location server 202 and may, in some embodiments, be part of location server 202 (e.g., contained in a storage medium in location server 202). Almanac 204 is configured to store identification and location parameters for the access points and base stations (e.g., eNBs) and antennas within the serving network 206 and may comprise a BSA of the type previously described here.

FIG. 2 shows N eNBs 210-1, 210-2, . . . , 210-N and 212 that each support a single cell using a single antenna labelled A1, A2 to AN, and AE. It should be understood that in other implementations, a base station may employ multiple antennas. Antennas A1, A2 to AN, and AE may support transmission of signals between UE 100 and eNBs 210-1, 210-2, . . . , 210-N and 212 through wireless links T1, T2, . . . , TN and TD1, which may support uplink and downlink channels. According to an embodiment, serving network 206 may implement one or more aspects of LTE Downlink Carrier Aggregation (DLCA). In a particular implementation, a mobile device may operate in an LTE carrier network that has implemented DLCA enabling the mobile device to receive downlink messages from multiple different base stations contemporaneously. From time to time a mobile device operating in an implementation of DLCA may transmit messages on any one of multiple different uplink channels to different base stations. In the particular implementation shown in FIG. 2, serving network 206 may implement DLCA in that mobile device 100 may transmit messages on any one of multiple different uplink channels to eNBs 210-1, 210-2, . . . , 210-N and 212.

In an implementation of DLCA, mobile device 100 may designate one base station (e.g., eNB 212) as serving a primary cell while other base stations (e.g., eNBs 210-1, 210-2, . . . , 210-N) may serve secondary cells such that mobile device 100 may access service on an uplink channel to the primary cell and receive messages in downlink channels from the primary cell and the secondary cells. In this context, a “primary cell” as referred to herein means a cell in a cellular communication network on which a mobile device currently operates over an uplink connection on a primary frequency channel and a downlink connection in an established initial connection or a connection re-established in a handover procedure. In a particular implementation, a mobile device may establish a radio resource control (RRC) connection to a primary cell exclusively of other cells in communication with the mobile device. It should be understood, however, that this is merely an example implementation of a primary cell and claimed subject matter is not limited in this respect. One or more “secondary cells” as referred to herein means a cell in a cellular communication network may provide a downlink connection to provide messages to the mobile device, but may not provide an uplink connection to the mobile device. According to an embodiment, a secondary cell may transition to being a primary cell in response to changing channel conditions.

According to an embodiment, mobile device 100 in a LTE environment may continuously monitor channel conditions of wireless links T1, T2, . . . , TN and TD1, and from time to time, and forward observations or measurements of downlink signals in support of handover events (e.g., executed by serving network 206). For example, if eNB 212 is a base station of a primary cell and serving network 206 detects that channel conditions of wireless link TD1 have degraded relative to channel conditions of an of wireless links T1, T2, . . . , TN (e.g., based on measurements or observations of downlink signals provided by mobile device 100), serving network 206 may execute a handover event designating one of eNB 210-1, 210-2, . . . , 210-N as the primary cell (e.g., to which mobile device 100 is to have an uplink connection on a primary frequency). In one implementation, mobile device 100 and/or serving network 206 may evaluate channel conditions of wireless links T1, T2, . . . , TN and TD1 based, at least in part, on measurements or observations collected in an LTE A3 or A5 measurement report. For example, channel conditions may be evaluated based, at least in part, on a measured received power of downlink channel signals as collected in an LTE A5 measurement report. In one scenario, a wireless link T1, T2, . . . , TN or TD1 may be determined to have an improved channel condition if a received power on a downlink channel increases. Similarly, a first wireless link may be determined to have a better channel condition than a channel condition of a second wireless link if received power on downlink channel of the first wireless link is measurably higher than a received power on a downlink channel of the second wireless link.

As pointed out above, signals transmitted by mobile device 100 on an uplink channel of a wireless link (e.g., wireless link TD1) may interfere with or jam one or more other RF functions of the mobile device such as, for example, processing signals transmitted by a GNSS (e.g., SPS signals 159 transmitted from space vehicles 160), processing signals received from a Bluetooth® transmitter, just to provide a few examples.

According to an embodiment, if a currently used uplink communication channel to a particular cell (e.g., a primary cell) is likely to interfere with or jam other RF functions, a mobile device may trigger a transition to use of a different, non-interfering, uplink communication channel to a different cell (e.g., secondary cell). Here, the mobile device may trigger such a transition to use of an uplink communication channel of a different cell by increasing a reported measurement of received power of a downlink signal transmitted by the different cell. In an implementation, the particular cell may be operated by a first carrier operator and the different cell may be operated by a second carrier operator different from the first carrier operator.

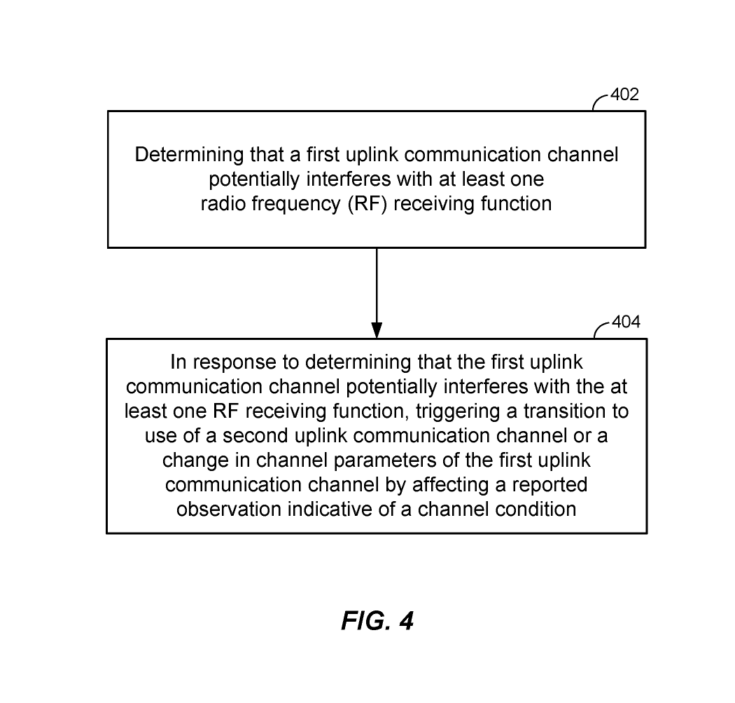

FIG. 4 is a flow diagram of a process to trigger an event to transition to use of a different uplink communication channel or use of different communication channel parameters according to an embodiment. As discussed above, a mobile device may have multiple RF functions in addition to LTE communication such as, for example, processing SPS signals for positioning operations or processing Bluetooth® signals. Block 402 may comprise determining whether an uplink communication channel potentially interferes with at least one receiving radio frequency function that is currently active. In this context, a “receiving radio frequency function” as referred to herein means at least one activity or application of a mobile device that relies, at least in part, on measurements, observations, indications, parameters, etc. obtained based on one or more signals received at a receiver. For example, as discussed above, such a receiving radio frequency function may comprise receiving and processing SPS signals for positioning operations or receiving and processing messages in a downlink channel of a wireless Bluetooth link. It should be understood, however, that these are merely examples of a receiving radio frequency function, and that claimed subject matter is not limited in this respect. In one implementation, a receiving radio frequency function at block 402 may comprise a “currently active” receiving radio frequency function. Further in this context, “currently active” as referred to herein means a current state of a particular receiving radio frequency function during which signals received at a receiver are to be processed (e.g., to obtain measurements, observations, indications, parameters, etc.) in support of the receiving radio frequency function.

As pointed out above, block 402 may categorize or otherwise identify a particular active uplink communication channel relating, at least in part, to an uplink transmission frequency band or related harmonics. In an LTE downlink channel aggregation (DLCA) implementation, for example, block 402 may characterize a particular uplink communication channel to a primary cell as being a particular LTE band (e.g., LTE band 13, 40 12, etc.). Further as pointed out above, block 402 may associate the identified or characterized active uplink communication channel with one or more radio frequency functions (e.g., L1 band GNSS or Bluetooth®) that are potentially jammed (or interfered with) by the identified or characterized active uplink communication channel (e.g., LTE TDD band 40, LTE FDD band 7, 13 or 14). According to an embodiment, this may be implemented by a look-up table stored in a memory. Alternatively, block 402 may comprise performing computations to determine whether the uplink communication channel introduces interference impacting an RF receiving function (e.g., performing computations to determine whether the uplink communication channel in combination with other transmission introduces intermodulation distortion affecting the RF receiving function). Block 402 may then further determine whether any of the associated one or more receiving radio frequency functions are currently active by, for example, evaluating available processing parameters (e.g., parameters available from a local operating system) to determine that the identified or characterized active uplink communication channel potentially interferes with the associated one or more radio frequency functions.

In response to a determination at block 402 that an uplink communication channel potentially interferes with at least one radio frequency function that currently active, block 404 may trigger an event to transition to use of an uplink communication channel or a change in channel parameters of the first uplink communication channel by affecting or altering one or more parameters indicative of a reported observation indicative of a channel condition. Such a reported observation of a channel condition may comprise, for example, a measured power of a received downlink signal, estimated or measured noise level, observation of an atmospheric condition, just to provide a few examples of an observation of a channel condition. Furthermore, such a reported observation of a channel condition may comprise an observation of a channel condition of a communication channel to the first cell, the second cell, some other cell, or a combination thereof.

In one particular implementation, the first and second uplink communication channels referred to in block 404 may comprise uplink communication channels to two distinct base station transceiver devices. Alternatively, the first and second uplink communication channels referred to in block 404 may comprise uplink communication channels to a single base station transceiver device capable of allocating multiple uplink communication channels to a single client device. In another alternative implementation, the first and second uplink communication channels referred to in block 404 may comprise uplink communication channels to one or more devices configured to provide service to a single macrocell (e.g., to devices servicing separate microcells within the same macrocell). It should be understood, however, that these are merely examples of how two different uplink communication channels may be configured for a mobile device, and claimed subject matter is not limited in this respect.

As pointed out above, block 404 may comprise triggering a change in channel parameters of the first uplink communication channel. In an example implementation, such a change in channel parameters may affect or reduce interference affecting or desensing one or more RF receiving functions. Such channel parameters may include, for example, transmission power, data rate, encoding, resource block (RB) allocation within the first uplink communication channel or frequency, just to provide a few examples. In one example, such a change in channel parameters of the first uplink communication channel may comprise an exchange of control messages with a base station transceiver (e.g., in a control channel of the first uplink communication channel) to establish subsequent transmission in the uplink communication channel according to the changed channel parameters.

Regarding a change in channel parameters including a change in an RB allocation in the first uplink communication channel, it may be noted that RBs in the first uplink communication channel may be allocated to less than an entirety of usable bandwidth within the first uplink communication channel. Accordingly, a network (e.g., at an eNode B serving a cell) may vary a transmission frequency of RBs within a total bandwidth of the first uplink communication channel. By changing a transmission frequency of RBs within a total bandwidth of the first uplink communication channel, interference detected at block 402 may be reduced or avoided.

In a particular implementation, an event to transition use of a first uplink communication channel to use of a second uplink communication channel cell or a change in channel parameters of the first uplink communication channel may be triggered by affecting parameters (e.g., in memory) reporting a measurement of received power of a downlink signal transmitted by the primary cell and/or the secondary cell (e.g., in an LTE A5 measurement report). In an example implementation, block 404 may initiate an event to use of a different uplink communication channel by transmitting one or more messages to a network entity comprising the affected reported observation of the channel condition.

In a particular implementation, block 404 may affect parameters reporting a measurement of received power of a downlink signal transmitted by the primary cell or the secondary cell according to expressions (1) as follows:

P_{RSRP}=P_{RSRP}−Δ

S_{RSRP}=S_{RSRP}+Δ (1)

where:

P_{RSRP} is a parameter representing an observation of received power of a downlink signal transmitted by a primary cell;

S_{RSRP} is a parameter representing an observation of received power of a downlink signal transmitted by a secondary cell; and

Δ is a value representing an amount that is sufficient to trigger a network assisted handover event.

According to an embodiment, block 404 may further comprise selecting the particular second cell from among multiple different candidate cells based on one or more criteria. For example, block 404 may select the second cell as having an available uplink channel that does not interfere with or jam the particular RF receiving function or other RF receiving function. For example, block 404 may evaluate the aforementioned look-up table to determine whether any of the available uplink channels to the multiple different candidate cells do not likely interfere with or jam the particular RF receiving function. From among the available uplink channels to the multiple different candidate cells determined to not likely interfere with or jam the particular RF receiving function, block 404 may apply additional criteria. For example, block 404 may select an available uplink channels to the multiple different candidate cells from a link having a highest received downlink signal strength. In another example, block 404 may select a second cell from one or more cells having uplink quality sufficient for a voice call (e.g., based, at least in part on measured or observed downlink parameters such as RSRP or RSRQ exceeding threshold values).

According to an embodiment, processes of blocks 402 and 404 may be performed in response to detection of an E911 event. For example, in a particular scenario in which positioning based on OTDOA is not available, an E911 event may initiate an attempt to acquire SPS signals from a GNSS to obtain a position fix. As such, block 402 may determine that an uplink communication channel interferes with or jams an activated GNSS function, and block 404 may trigger handover event as a consequence.

In a particular scenario in connection with block 404, the first cell comprises a first a primary cell may be operated by a first carrier operator and the second cell may be operated by a second carrier operator different from the first carrier operator. Here, block 404 may select the second cell by determining a first expected transmission power in a first uplink channel to the first cell and a second expected transmission power in a second uplink channel to the second cell. The second cell may then be selected based, at least in part, on the first expected transmission power and the second expected transmission power.

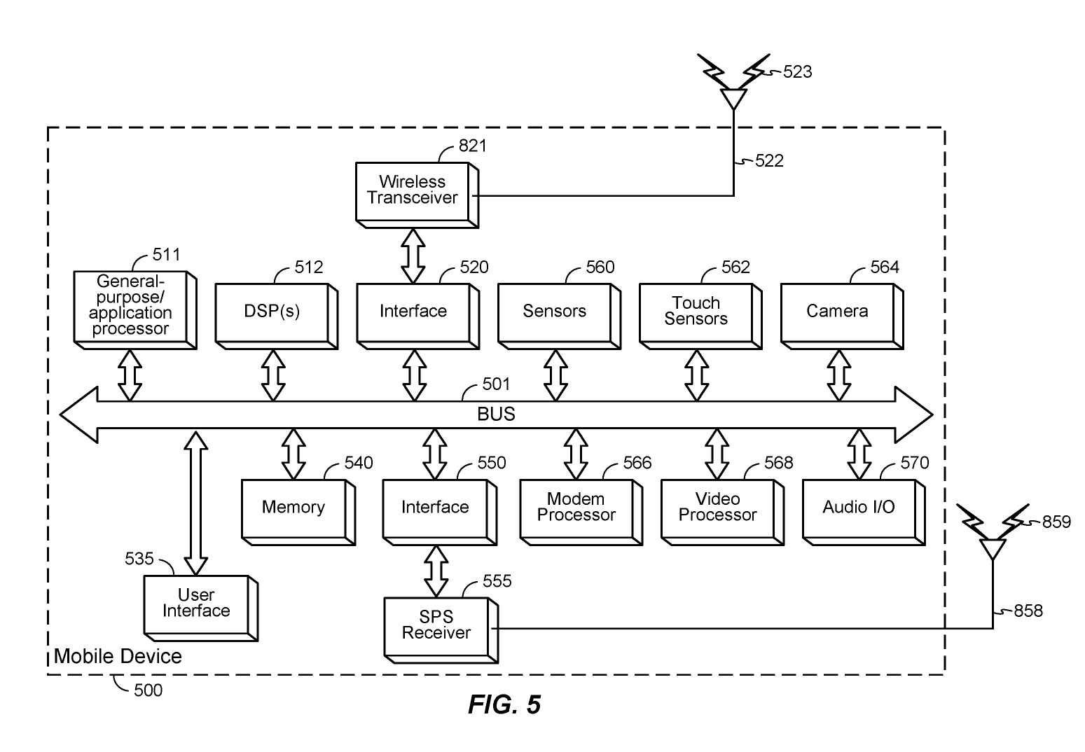

Subject matter shown in FIG. 5 may comprise features, for example, of a computing device, in an embodiment. It is further noted that the term computing device, in general, refers at least to one or more processors and a memory connected by a communication bus. Likewise, in the context of the present disclosure at least, this is understood to refer to sufficient structure within the meaning of 35 USC § 112(f) so that it is specifically intended that 35 USC § 112(f) not be implicated by use of the term “computing device,” “wireless station,” “wireless transceiver device,” “mobile device” and/or similar terms; however, if it is determined, for some reason not immediately apparent, that the foregoing understanding cannot stand and that 35 USC § 112(f) therefore, necessarily is implicated by the use of the term “computing device,” “wireless station,” “wireless transceiver device,” “mobile device” and/or similar terms, then, it is intended, pursuant to that statutory section, that corresponding structure, material and/or acts for performing one or more functions be understood and be interpreted to be described at least in FIG. 4, and corresponding text of the present disclosure.

FIG. 5 is a schematic diagram of a mobile device 500 according to an embodiment. Mobile device 100 shown in FIGS. 1 and 2 may comprise one or more features of mobile device 500 shown in FIG. 5. In certain embodiments, mobile device 500 may comprise a wireless transceiver 521 which is capable of transmitting and receiving wireless signals 523 via wireless antenna 522 over a wireless communication network. Wireless transceiver 521 may be connected to bus 501 by a wireless transceiver bus interface 520. Wireless transceiver bus interface 520 may, in some embodiments be at least partially integrated with wireless transceiver 521. Some embodiments may include multiple wireless transceivers 521 and wireless antennas 522 to enable transmitting and/or receiving signals according to corresponding multiple wireless communication standards such as, for example, versions of IEEE Standard 802.11, CDMA, WCDMA, LTE, UMTS, GSM, AMPS, Zigbee, Bluetooth and a 5G or NR radio interface defined by 3GPP, just to name a few examples. In a particular implementation, wireless transceiver 521 may transmit signals on an uplink channel and receive signals on a downlink channel as discussed above.

Mobile device 500 may also comprise SPS receiver 555 capable of receiving and acquiring SPS signals 859 via SPS antenna 558 (which may be the same as antenna 522 in some embodiments). SPS receiver 555 may also process, in whole or in part, acquired SPS signals 559 for estimating a location of mobile device 500. In some embodiments, general-purpose processor(s) 511, memory 540, digital signal processor(s) (DSP(s)) 512 and/or specialized processors (not shown) may also be utilized to process acquired SPS signals, in whole or in part, and/or calculate an estimated location of mobile device 500, in conjunction with SPS receiver 555. Storage of SPS, TPS or other signals (e.g., signals acquired from wireless transceiver 521) or storage of measurements of these signals for use in performing positioning operations may be performed in memory 540 or registers (not shown). General-purpose processor(s) 511, memory 540, DSP(s) 512 and/or specialized processors may provide or support a location engine for use in processing measurements to estimate a location of mobile device 500. In a particular implementation, all or portions of actions or operations set forth for process 500 may be executed by general-purpose processor(s) 511 or DSP(s) 512 based on machine-readable instructions stored in memory 540. For example general-purpose processor(s) 511 or DSP(s) 512 may process a downlink signal acquired by wireless transceiver 521 to, for example, determine timing advance parameters and an estimated location as described above.

Also shown in FIG. 5, digital signal processor(s) (DSP(s)) 512 and general-purpose processor(s) 511 may be connected to memory 540 through bus 501. A particular bus interface (not shown) may be integrated with the DSP(s) 512, general-purpose processor(s) 511 and memory 540. In various embodiments, functions may be performed in response to execution of one or more machine-readable instructions stored in memory 540 such as on a computer-readable storage medium, such as RAM, ROM, FLASH, or disc drive, just to name a few example. The one or more instructions may be executable by general-purpose processor(s) 511, specialized processors, or DSP(s) 512. Memory 540 may comprise a non-transitory processor-readable memory and/or a computer-readable memory that stores software code (programming code, instructions, etc.) that are executable by processor(s) 511 and/or DSP(s) 512 to perform functions or actions described above in connection with FIG. 5.

Also shown in FIG. 5, a user interface 535 may comprise any one of several devices such as, for example, a speaker, microphone, display device, vibration device, keyboard, touch screen, just to name a few examples. In a particular implementation, user interface 535 may enable a user to interact with one or more applications hosted on mobile device 500. For example, devices of user interface 535 may store analog or digital signals on memory 540 to be further processed by DSP(s) 512 or general purpose processor 511 in response to action from a user. Similarly, applications hosted on mobile device 500 may store analog or digital signals on memory 540 to present an output signal to a user. In another implementation, mobile device 500 may optionally include a dedicated audio input/output (I/O) device 570 comprising, for example, a dedicated speaker, microphone, digital to analog circuitry, analog to digital circuitry, amplifiers and/or gain control. It should be understood, however, that this is merely an example of how an audio I/O may be implemented in a mobile device, and that claimed subject matter is not limited in this respect. In another implementation, mobile device 500 may comprise touch sensors 562 responsive to touching or pressure on a keyboard or touch screen device.

Mobile device 500 may also comprise a dedicated camera device 564 for capturing still or moving imagery. Camera device 564 may comprise, for example an imaging sensor (e.g., charge coupled device or CMOS imager), lens, analog to digital circuitry, frame buffers, just to name a few examples. In one implementation, additional processing, conditioning, encoding or compression of signals representing captured images may be performed at general purpose/application processor 511 or DSP(s) 512. Alternatively, a dedicated video processor 568 may perform conditioning, encoding, compression or manipulation of signals representing captured images. Additionally, video processor 568 may decode/decompress stored image data for presentation on a display device (not shown) on mobile device 500.

Mobile device 500 may also comprise sensors 560 coupled to bus 501 which may include, for example, inertial sensors and environment sensors. Inertial sensors of sensors 560 may comprise, for example accelerometers (e.g., collectively responding to acceleration of mobile device 500 in three dimensions), one or more gyroscopes or one or more magnetometers (e.g., to support one or more compass applications). Environment sensors of mobile device 500 may comprise, for example, temperature sensors, barometric pressure sensors, ambient light sensors, camera imagers, microphones, just to name few examples. Sensors 560 may generate analog or digital signals that may be stored in memory 540 and processed by DPS(s) 512 or general purpose application processor 511 in support of one or more applications such as, for example, applications directed to positioning or navigation operations.

In a particular implementation, mobile device 500 may comprise a dedicated modem processor 566 capable of performing baseband processing of signals received and downconverted at wireless transceiver 521 or SPS receiver 555. Similarly, modem processor 566 may perform baseband processing of signals to be upconverted for transmission by wireless transceiver 521. In alternative implementations, instead of having a dedicated modem processor, baseband processing may be performed by a general purpose processor or DSP (e.g., general purpose/application processor 511 or DSP(s) 512). It should be understood, however, that these are merely examples of structures that may perform baseband processing, and that claimed subject matter is not limited in this respect.

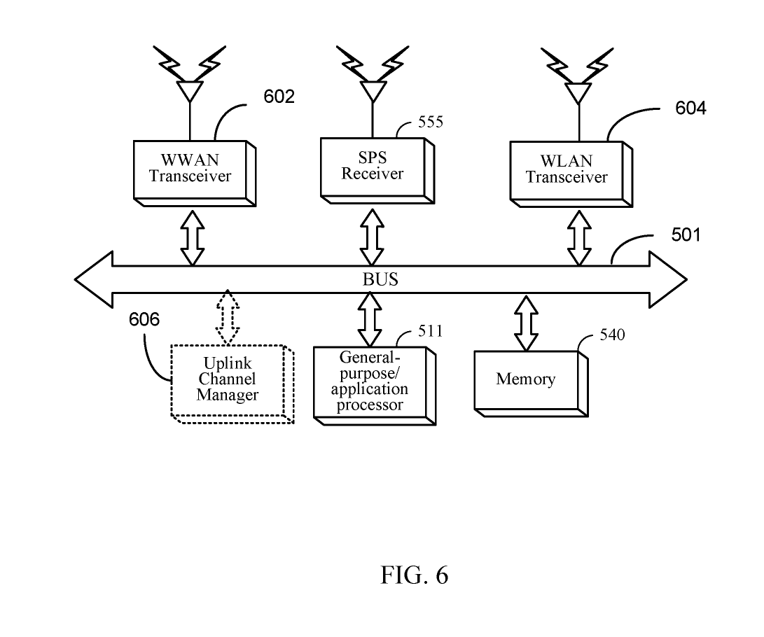

FIG. 6 is a schematic diagram of an alternative features of mobile device 500 according to a particular implementation. Here, wireless transceiver 521 may comprise multiple wireless transceiver devices for multiple different radio access technologies including WWAN transceiver 602 and WLAN transceiver 604. Furthermore, WWAN transceiver 602 may be configured to communicate with multiple base stations using uplink carrier aggregation or downlink carrier aggregation as discussed herein. Here, determination of whether a first uplink communication channel potentially interferes with at least one RF receiving function at block 402 and triggering transition to use of a second uplink communication channel or change to channel parameters of the first uplink communication channel by affecting a reported observation indicative of a channel condition at block 404 may occur under the control of computer-readable instructions (e.g., stored on memory 540) executing on general purpose/application processor 511. Alternatively, selection of a second communication channel at block 304 may occur at an uplink channel manager device 606 operating as a low power controller. According to an embodiment, general purpose/application processor 511 or uplink channel manager device 606 may determine whether a first uplink communication channel potentially interferes with at least one receiving function based on control messages received from WWAN transceiver 602 and SPS receiver 555. For example, WWAN transceiver 602 and SPS receiver 555 may forward messages on bus 501 to uplink channel manager device 606 or general purpose/application processor 511 indicating communication channels available in a WWAN and a WLAN. Uplink channel manager device 606 or general purpose/application processor 511 may then provide control messages on bus 501 to WWAN transceiver 602 indicating how a reported observation indicative of a channel condition is to be affected, for example. In an alternative implementation, control messages from uplink channel manager device 606 or general purpose/application processor 511 to WWAN transceiver 602 lists of available communication channels available for selection as a second uplink communication channel at WWAN transceiver 602 for establishing or maintaining a communication connection.

As used herein, the terms “mobile device” and “user equipment” (UE) are used synonymously to refer to a device that may from time to time have a location that changes. The changes in location may comprise changes to direction, distance, orientation, etc., as a few examples. In particular examples, a mobile device may comprise a cellular telephone, wireless communication device, user equipment, laptop computer, other personal communication system (PCS) device, personal digital assistant (PDA), personal audio device (PAD), portable navigational device, and/or other portable communication devices. A mobile device may also comprise a processor and/or computing platform adapted to perform functions controlled by machine-readable instructions.

The methodologies described herein may be implemented by various means depending upon applications according to particular examples. For example, such methodologies may be implemented in hardware, firmware, software, or combinations thereof. In a hardware implementation, for example, a processing unit may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other devices units designed to perform the functions described herein, or combinations thereof.

“Instructions” as referred to herein relate to expressions which represent one or more logical operations. For example, instructions may be “machine-readable” by being interpretable by a machine for executing one or more operations on one or more data objects. However, this is merely an example of instructions and claimed subject matter is not limited in this respect. In another example, instructions as referred to herein may relate to encoded commands which are executable by a processing circuit having a command set which includes the encoded commands. Such an instruction may be encoded in the form of a machine language understood by the processing circuit. Again, these are merely examples of an instruction and claimed subject matter is not limited in this respect.

“Storage medium” as referred to herein relates to media capable of maintaining expressions which are perceivable by one or more machines. For example, a storage medium may comprise one or more storage devices for storing machine-readable instructions or information. Such storage devices may comprise any one of several media types including, for example, magnetic, optical or semiconductor storage media. Such storage devices may also comprise any type of long term, short term, volatile or non-volatile memory devices. However, these are merely examples of a storage medium, and claimed subject matter is not limited in these respects.

Some portions of the detailed description included herein are presented in terms of algorithms or symbolic representations of operations on binary digital signals stored within a memory of a specific apparatus or special purpose computing device or platform. In the context of this particular specification, the term specific apparatus or the like includes a general purpose computer once it is programmed to perform particular operations pursuant to instructions from program software. Algorithmic descriptions or symbolic representations are examples of techniques used by those of ordinary skill in the signal processing or related arts to convey the substance of their work to others skilled in the art. An algorithm is here, and generally, is considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals, or the like. It should be understood, however, that all of these or similar terms are to be associated with appropriate physical quantities and are merely convenient labels. Unless specifically stated otherwise, as apparent from the discussion herein, it is appreciated that throughout this specification discussions utilizing terms such as “processing,” “computing,” “calculating,” “determining” or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

Wireless communication techniques described herein may be in connection with various wireless communications networks such as a wireless wide area network (WWAN), a wireless local area network (WLAN), a wireless personal area network (WPAN), and so on. The term “network” and “system” may be used interchangeably herein. A WWAN may be a Code Division Multiple Access (CDMA) network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, or any combination of the above networks, and so on. A CDMA network may implement one or more radio access technologies (RATs) such as cdma2000, Wideband CDMA (WCDMA), to name just a few radio technologies. Here, cdma2000 may include technologies implemented according to IS-95, IS-2000, and IS-856 standards. A TDMA network may implement Global System for Mobile Communications (GSM), Digital Advanced Mobile Phone System (D-AMPS), or some other RAT. GSM and WCDMA are described in documents from a consortium named “3rd Generation Partnership Project” (3GPP). Cdma2000 is described in documents from a consortium named “3rd Generation Partnership Project 2” (3GPP2). 3GPP and 3GPP2 documents are publicly available. 4G Long Term Evolution (LTE) and 5G or New Radio (NR) communications networks may also be implemented in accordance with claimed subject matter, in an aspect. A WLAN may comprise an IEEE 802.11x network, and a WPAN may comprise a Bluetooth network, an IEEE 802.15x, for example. Wireless communication implementations described herein may also be used in connection with any combination of WWAN, WLAN or WPAN.

In another aspect, as previously mentioned, a wireless transmitter or access point may comprise a femtocell, utilized to extend cellular telephone service into a business or home. In such an implementation, one or more mobile devices may communicate with a femtocell via a code division multiple access (CDMA) cellular communication protocol, for example, and the femtocell may provide the mobile device access to a larger cellular telecommunication network by way of another broadband network such as the Internet.

The terms, “and,” and “or” as used herein may include a variety of meanings that will depend at least in part upon the context in which it is used. Typically, “or” if used to associate a list, such as A, B or C, is intended to mean A, B, and C, here used in the inclusive sense, as well as A, B or C, here used in the exclusive sense. Reference throughout this specification to “one example” or “an example” means that a particular feature, structure, or characteristic described in connection with the example is included in at least one example of claimed subject matter. Thus, the appearances of the phrase “in one example” or “an example” in various places throughout this specification are not necessarily all referring to the same example. Furthermore, the particular features, structures, or characteristics may be combined in one or more examples. Examples described herein may include machines, devices, engines, or apparatuses that operate using digital signals. Such signals may comprise electronic signals, optical signals, electromagnetic signals, or any form of energy that provides information between locations.

While there has been illustrated and described what are presently considered to be example features, it will be understood by those skilled in the art that various other modifications may be made, and equivalents may be substituted, without departing from claimed subject matter. Additionally, many modifications may be made to adapt a particular situation to the teachings of claimed subject matter without departing from the central concept described herein. Therefore, it is intended that claimed subject matter not be limited to the particular examples disclosed, but that such claimed subject matter may also include all aspects falling within the scope of the appended claims, and equivalents thereof.

What is claimed is:

1. A method at a mobile device comprising:
determining whether a first uplink communication channel potentially interferes with at least one radio frequency (RF) receiving function; and
in response to determining that the uplink channel potentially interferes with the at least one RF receiving function, triggering a transition to use of a second uplink communication channel or a change to channel parameters of the first uplink communication channel by affecting a reported observation indicative of a channel condition.

2. The method of claim 1, wherein the second uplink communication channel is selected from among uplink communication channels to a plurality of base station transceivers, and wherein the mobile device is configured to receive on a downlink communication channel from a base station transceiver that is receiving the second uplink communication channel.

3. The method of claim 1, wherein the first uplink communication channel is to a first base station transceiver and the second uplink communication channel is to a second base station transceiver, and wherein the reported observation indicative of the channel condition comprises a reported measurement of received power of one or more signals received in a downlink signal transmitted by the first base station transceiver or a downlink signal transmitted by the second base station transceiver, or a combination thereof.

4. The method of claim 3, wherein the reported measurement of the received power is received from an A5/A3 measurement report.

5. The method of claim 1, wherein the at least one RF receiving function comprises a global navigation satellite system function or a Bluetooth function, or a combination thereof.

6. The method of claim 1, wherein determining whether the first uplink communication channel potentially interferes at least one receiving radio frequency channel comprises accessing a look-up table.

7. The method of claim 1, wherein the second uplink communication channel is determined to not interfere with the RF receiving function, the method further comprising selecting the second uplink communication channel in response to an E911 event.

8. The method of claim 1, and wherein the first uplink communication channel is to a first base station transceiver operated by a first carrier and the second uplink communication channel is to a second base station transceiver operated by a second carrier, and wherein the method further comprises:
determining a first expected transmission power in the first uplink communication channel and a second expected transmission power in the second uplink communication channel; and
selecting the second uplink communication channel based, at least in part, on the first expected transmission power and the second expected transmission power.

9. The method of claim 1, wherein the second uplink communication channel is selected from one or more uplink communication channels having uplink quality sufficient for a voice call.

10. The method of claim 1, and further comprising selecting the second uplink communication channel based, at least in part, on a determination of an absence of interference from transmission in the second uplink communication channel impacting the at least one RF receiving function.

11. The method of claim 1, wherein the change to channel parameters of the first uplink communication channel comprises a change to transmission power, data rate, encoding or resource block (RB) allocation within the first uplink communication channel, or a combination thereof.

12. A mobile device comprising:
at least one receiver enabling at least one radio frequency (RF) receiving function; and
one or more processors coupled to the at least one receiver, the one or more processors configured to:
determine whether a first uplink communication channel potentially interferes with the at least one receiving radio frequency function; and
in response to determining that the first uplink communication channel potentially interferes with the at least one RF receiving function, triggering a transition to use of a second uplink communication channel or a change to channel parameters of the first uplink channel by affecting a reported observation indicative of a channel condition.

13. The mobile device of claim 12, wherein the second uplink communication channel is selected from among uplink channels to a plurality of base station transceivers, and wherein the at least one receiver is configured to receive on a downlink signal from a base station transceiver receiving the second uplink communication channel.

14. The mobile device of claim 12, wherein the first uplink communication channel is to a first base station transceiver and the second uplink communication channel is to a second base station transceiver, and wherein the reported observation indicative of the channel condition comprises a reported measurement of received power of one or more signals received in a downlink signal transmitted by the first base station transceiver or a downlink signal transmitted by the second base station transceiver, or a combination thereof.

15. The mobile device of claim 14, wherein the reported measurement of the received power is received from an A5/A3 measurement report.

16. The mobile device of claim 12, wherein the at least one RF receiving function comprises a global navigation satellite system function or a Bluetooth function, or a combination thereof.

17. The mobile device of claim 12, wherein the one or more processors are further configured to determine whether the first uplink communication channel potentially interferes at least one receiving radio frequency channel based, at least in part, on access of a look-up table.

18. The mobile device of claim 12, wherein the second uplink communication channel is determined to not interfere with the RF receiving function, and wherein the one or more processors are further configured to select the second uplink communication channel in response to an E911 event.

19. The mobile device of claim 12, and wherein the first uplink communication channel is to a first base station transceiver operated by a first carrier and the second uplink communication channel is to a base station transceiver operated by a second carrier, and wherein the one or more processors are further configured to:
determine a first expected transmission power in the first uplink communication channel and a second expected transmission power in the second uplink communication channel; and
select the second uplink communication channel based, at least in part, on the first expected transmission power and the second expected transmission power.

20. The mobile device of claim 12, wherein the second uplink communication channel is selected from one or more uplink communication channels having uplink quality sufficient for a voice call.

21. The mobile device of claim 12, wherein the one or more processors are further configured to select the second uplink communication channel based, at least in part, on a determination of an absence of interference from transmission in the second uplink communication channel impacting the at least one RF receiving function.

22. The mobile device of claim 12, wherein the change to channel parameters of the first uplink communication channel comprises a change to transmission power, data rate, encoding or resource block (RB) allocation within the first uplink communication channel, or a combination thereof.

23. A storage medium comprising computer-readable instructions stored thereon that are executable by one or more processors of a mobile device to:
determine whether a first uplink communication channel potentially interferes with at least one radio frequency (RF) receiving function of the mobile device; and
in response to a determination that the first uplink communication channel potentially interferes with the at least one RF receiving function, trigger a transition to use of a second uplink communication channel or a change to channel parameters of the first uplink communication channel by affecting a reported observation indicative of a channel condition.

24. The storage medium of claim 23, wherein the second uplink communication channel is selected from a plurality of uplink communication channels to a plurality of base stations, and wherein the at least one receiver is configured to receive a downlink communication channel from a base station transceiver that is receiving the second uplink communication channel.

25. The storage medium of claim 23, wherein the first uplink communication channel is to a first base station transceiver and the second uplink communication channel is to a second base station transceiver, and wherein the reported observation indicative of the channel condition comprises a reported measurement of received power of one or more signals received in a downlink signal transmitted by the first base station transceiver or in a downlink signal transmitted by the second base station transceiver, or a combination thereof.

26. The storage medium of claim 25, wherein the reported measurement of the received power is received from an A5/A3 measurement report.

27. The storage medium of claim 23, wherein the at least one RF receiving function comprises a global navigation satellite system function or a Bluetooth function, or a combination thereof.

28. The storage medium of claim 23, wherein the instructions are further executable by the one or more processors to determine that the first uplink communication channel potentially interferes at least one receiving radio frequency channel based, at least in part, on access of a look-up table.

29. The storage medium of claim 23, wherein the second uplink communication channel is determined to not interfere with the RF receiving function, and wherein the instructions are further executable by the one or more processors to select the second uplink communication channel in response to an E911 event.

30. The storage medium of claim 23, and wherein the first uplink communication channel is to a first base station transceiver operated by a first carrier and the second uplink communication channels to a second base station transceiver operated by a second base station transceiver, and wherein the instructions are further executable by the one or more processors to:
determine a first expected transmission power in the first uplink communication channel and a second expected transmission power in the second uplink communication channel; and
select the second uplink communication channel based, at least in part, on the first expected transmission power and the second expected transmission power.

31. The storage medium of claim 23, wherein the second uplink communication channel is selected from one or more uplink communication channels having uplink quality sufficient for a voice call.

32. The storage medium of claim 23, wherein the instructions are further executable by one or more processors to select the second uplink communication channel based, at least in part, on a determination of an absence of interference from transmission in the second uplink communication channel impacting the at least one RF receiving function.

33. The storage medium of claim 23, wherein the change to channel parameters of the first uplink communication channel comprises a change to transmission power, data rate, encoding or resource block (RB) allocation within the first uplink communication channel, or a combination thereof.

34. A mobile device comprising:
means for determining whether a first uplink communication channel potentially interferes with at least one radio frequency (RF) receiving function; and
means for triggering a transition to use of a second uplink communication channel or a change to channel parameters of the first uplink communication channel by affecting a reported observation of indicative of a channel condition in response to a determination that the uplink channel potentially interferes with the at least one RF receiving function.

35. The mobile device of claim 34, wherein the second uplink communication channel is selected from a plurality of uplink communication channels to a plurality of base station transceivers, and wherein the mobile device is configured to receive on a downlink communication channel from a base station transceiver that is receiving the second uplink communication channel.

36. The mobile device of claim 34, wherein the first uplink communication channel is to a first base station transceiver and the second uplink communication channel is to a second base station transceiver, and wherein the reported observation indicative of the channel condition comprises a reported measurement of received power of one or more signals received in a downlink signal transmitted by the first base station transceiver or the second base station transceiver, or a combination thereof.

37. The mobile device of claim 36, wherein the reported measurement of the received power is received from an A5/A3 measurement report.

38. The mobile device of claim 34, wherein the at least one RF receiving function comprises a global navigation satellite system function or a Bluetooth function, or a combination thereof.

39. The mobile device of claim 34, wherein means for determining whether the first uplink communication channel potentially interferes at least one receiving radio frequency channel comprises means for accessing a look-up table.

40. The mobile device of claim 34, wherein the second uplink communication channel is determined to not interfere with the RF receiving function, and wherein the mobile device further comprises means for selecting the second uplink communication channel in response to an E911 event.

41. The mobile device of claim 34, and wherein the first uplink communication channel is to a first base station transceiver operated by a first carrier and the second uplink communication channel is to a second base station transceiver operated by a second carrier, and wherein the mobile device further comprises:
means for determining a first expected transmission power in the first uplink communication channel and a second expected transmission power in the second uplink communication channel; and
means for selecting the second uplink communication channel based, at least in part, on the first expected transmission power and the second expected transmission power.

42. The mobile device of claim 34, wherein the second uplink communication channel is selected from one or more uplink communication channels having uplink quality sufficient for a voice call.

43. The mobile device of claim 34, and further comprising means for selecting the second uplink communication channel based, at least in part, on a determination of an absence of interference from transmission in the second uplink communication channel impacting the at least one RF receiving function.

44. The mobile device of claim 34, wherein the change to channel parameters of the first uplink communication channel comprises a change to transmission power, data rate, encoding or resource block (RB) allocation within the first uplink communication channel, or a combination thereof.
